(19) United States
(12) Patent Application Publication
(10) Pub. No.: US 2012/0234866 A1
(43) Pub. Date: Sep. 20, 2012

(54) FOAM PUMP WITH SPRING ISOLATED FROM FLOW PATH

(76) Inventor: JISONG LIN, Shantou (TW)

(21) Appl. No.: 13/048,870

(22) Filed: Mar. 16, 2011

(51) Int. Cl. B67D 7/76

(52) U.S. Cl. 222/190

(57) ABSTRACT

A foam pump has a spring isolated from a flow path. Due to the arrangement of inner tube and outer tube of the pressing head and a spring installed between the inner tube and the outer tube, in the suction process, the liquid (or emulation) in the bottle flows through the inner channel of the inner tube and thus it does not contact with the outer tube so that the foams will not be polluted by the material spring. The spring is isolated with the foaming flow path so that it does not resist the flow of the foams; the liquid (or emulsion) does not contact the foams so that the foams are not polluted and thus the liquid in a bottle is retained purely; the liquid is not chemically reacted with the material of the spring and thus no harmful object generates.

### FIELD OF THE INVENTION

The present invention relates to pumps, in particular to a foam pump with a spring isolated from a flow path. The foam pumps of the present invention are suitable for the packing bottles of cosmetics, drug sundries, medical things, everyday used articles, etc.

### BACKGROUND OF THE INVENTION

Foam pumps are frequently used in the packing bottles of cosmetics, drug sundries, medical things, everyday used articles, etc. All the foaming pumps are installed with springs at inner sides thereof. The liquid or emulsions within the bottles passes through the springs and compressed by the pumps and then are sprayed out. However the springs will provide resist forces to the packing objects so that the liquid or emulsion can not flow out frequently. Moreover, the springs will pollute the packing objects so that the packing objects will react with the material of the springs so as to generate harmful objects to human bodies. Thus this prior way is not matched to the requirement of environmental protection, and is harmful to human bodies.

Thus there is an eager demand for a novel way to improve the above mentioned defects in the prior art. In this improvement structure, the spring is isolated with the liquid and the emulsion.

### SUMMARY OF THE INVENTION

The object of the present invention is to provide a foam pump with a spring isolated from a flow path, wherein the spring is isolated with the foaming flow path so that it does not resist the flow of the foams; the packed object is not in contact with the foams so that the foams are not polluted and thus the packed objects (liquid or foams) therein is retained purely; the packed object is not chemically reacted with the material of the spring and thus no harmful object generates; the operation of the present invention is convenient and easy with a steady flow and reliable output.

To achieve above object, the present invention provides a foam pump with a spring isolated from a flow path, comprising: A foam pump with a spring isolated from a flow path, comprising:

a pressing head having a pressing tube at an upper side thereof, an inner tube extending downwards from the pressing tube, and an outer tube enclosing an upper part of the inner tube; a lower part of the inner tube protruding from a lower opening of the outer tube; an inner side of the pressing tube being a hollow channel for outputting foams; the hollow channel of the pressing tube being communicated to the inner tube thereof;

a net tube installed within the inner tube of the pressing head and being communicated to the inner tube of the pressing tube; the net tube having a net-like structure;

a pump upper casing extended from a lower side of the outer tube of the pressing head; an upper side of the pump upper casing being an upper cylinder and a lower part of the pump upper casing being a lower cylinder; a lower inner wall of the lower cylinder of the pump upper casing being formed with threads; a space between the inner tube and outer tube of the pressing head being communicated to an inner space of the pump upper casing at a position above threads; the pump upper casing being slidable along an inner space between the inner tube and outer tube of the pressing head;

a spring winding around the inner tube of the pressing head; a lower end of the spring resisting against an inner flange extending from an inner wall of the pump upper casing;

an upper piston having a multi-stage structure and an upper stage thereof having a smaller diameter than a lower one; the upper piston being opened at an upper side and lower side thereof; the uppermost stage of the upper piston being protruded into a space between the inner tube of the pressing head and the net tube so that the inner space of the upper piston is communicated to the inner channel of the net tube and the inner channel of the inner tube; a plurality of through holes being formed in an annular transversal ring of the upper piston;

an air valve having a reduced size which is reduced from an upper side to a lower side thereof; the air valve having a hollow center which is opened at an upper side thereof; the air valve being communicated to the inner space of the net tube; a lowest part of the air valve having a sealed bottom;

a lower piston having a cylindrical structure with a hollow center; an upper hollow center of the lower piston receiving the air valve so that an upper side of the air valve being tightly engaged to an inner wall of the lower piston; an outer middle part of the lower piston being protruded with a flange; a plurality of slots being formed in the flange; a lower side of the lower piston being biforked into an inner ring and an outer ring;

an elastic sheet being a round cylinder and being tightly engaged into a recess in an inner wall of the upper piston; a lower side of the elastic sheet resisting against an upper wall of the flange of the lower position; a lower outer wall of the elastic sheet being extended with an elastic outer annular sheet which shields the plurality of through holes in an annular transversal ring of the upper piston from a lower side of the annular transversal ring; a lower inner wall of the elastic sheet being extended with an elastic inner annular sheet which shields the plurality of slots in the flange from the upper side of the flange;

a lower post having a cylindrical structure with a hollow center and a sealed lower bottom; a lower side of the lower post being formed with a tapered head; a tip of the tapered head facing downwards; an upper side of the lower post being tightly engaged with the inner ring of the lower piston;

a lower casing formed by an inner pipe and an outer pipe; the inner pipe and the outer pipe being connected at a lower bottom of the outer pipe; the outer pipe having a round cylindrical structure and being opened at an upper side thereof; an upper end of the lower casing expanding transversally to be engaged into an annular slot in an inner wall of the upper casing above the thread; the inner pipe being a round cylinder and being opened at an upper side thereof; an outer ring of the lower piston being tightly engaged to an inner wall of the inner pipe of the lower casing; a reduced pipe being extended from a lower end of the lower pipe and having a diameter smaller than that of the lower pipe; an upper side of the reduced pipe being protruded into an inner space of the lower pipe and being extended as a shoulder portion which resists against an upper surface of the tapered head of the lower post; an outer wall of the lowest stage of the upper piston movably resisting against an inner all of the outer pipe of the lower casing; and

a suction tube having an upper end inserted into an inner space of the reduced pipe to resist against an inner wall of the reduced pipe of the lower casing;

a washer enclosing an uppermost outer wall of the outer pipe of the lower casing and resisting against an inner wall of the lower cylinder of the pump upper casing.

The various objects and advantages of the present invention will be more readily understood from the following detailed description when read in conjunction with the appended drawing.

### BRIEF DESCRIPTION OF THE DRAWINGS

FIG. 1 is an exploded perspective view of the foam pump of the present invention.

FIG. 1-1 is a perspective view about the detailed structure of the elastic sheet of the present invention.

FIG. 2 shows an assembled outlook of the present invention.

FIG. 3 is a cross sectional schematic view of the foaming pump of the present invention, wherein the pump is in a static state.

FIG. 4 is a cross sectional schematic view of the foaming pump of the present invention, wherein the pump is in a pressing state.

FIG. 5 is a cross sectional schematic view of the foaming pump of the present invention, wherein the flow path is indicated.

FIG. 6 is a cross sectional schematic view of the foaming pump of the present invention, wherein the different cavities for filling liquid of the present invention is illustrated.

### DETAILED DESCRIPTION OF THE INVENTION

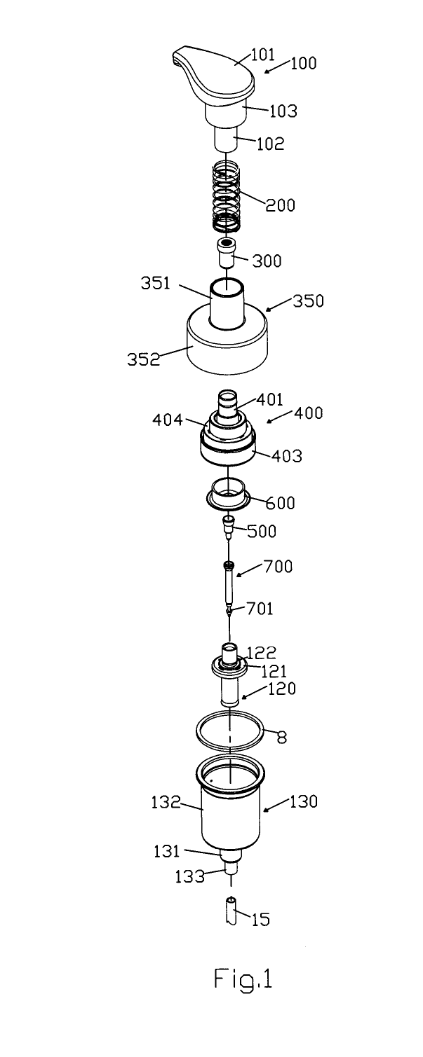

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims. In the following, the foam pump of the present invention is illustrated with reference to FIGS. 1, 2 and 3.

A pressing head 100 has an elliptical pressing tube 101 at an upper side thereof, an inner tube 102 extending downwards from the pressing tube 101, and an outer tube 103 enclosing an upper part of the inner tube 102. A lower part of the inner tube 102 protrudes from a lower opening of the outer tube 103. An inner side of the pressing tube 101 is a hollow channel for outputting foams. The hollow channel of the pressing tube 101 is communicated to the inner tube 102 thereof.

A net tube 300 is installed within the inner tube 102 of the pressing head 100 and is communicated to the inner tube 102 of the pressing tube 1. The net tube 300 has a net-like structure.

A pump upper casing 350 is extended from a lower side of the outer tube 103 of the pressing head 100. An upper side of the pump upper casing 350 is an upper cylinder 351 and a lower part of the pump upper casing 350 is a lower cylinder 352. A lower inner wall of the lower cylinder 352 of the pump upper casing 350 is formed with threads 9. The threads 9 serve to screw to outer threads of a bottle (not shown) with packed objects (such as liquid or emulsion). A space between the inner tube 102 and outer tube 103 of the pressing head 100 is communicated to an inner space of the pump upper casing 350 at a position above threads 9. In operation, the pump upper casing is slidable along an inner space between the inner tube 102 and outer tube 103 of the pressing head 100.

A spring 200 winds around the inner tube 102 of the pressing head 100. The spring 2 is a compressible and resilient spring. A lower end of the spring 200 resists against an inner flange 353 extending from an inner wall of the pump upper casing 350.

An upper piston 400 has a multi-stage structure and an upper stage thereof has a smaller diameter than a lower one; the upper piston 400 is opened at an upper side and lower side thereof. The uppermost stage 401 of the upper piston 400 is protruded into a space between the inner tube 102 of the pressing head 100 and the net tube 300 so that the inner space of the upper piston 400 is communicated to the inner channel of the net tube 300 and the inner channel of the inner tube 102. A plurality of through holes 405 are formed in an annular transversal ring 404 of the upper piston 400.

An air valve 500 has a reduced size which is reduced from an upper side to a lower side thereof. The air valve 500 has a hollow center which is opened at an upper side thereof. The air valve 500 is communicated to the inner space of the net tube 300. A lowest part of the air valve 500 has a sealed bottom. By a large suction force, the liquid can flow through the periphery of the air valve in force to flow upwards to be sprayed out from a mouth 104 of the pressing head 100.

A lower piston 120 has a cylindrical structure with a hollow center. An upper hollow center of the lower piston 120 receives the air valve 500 so that an upper side of the air valve 500 is tightly engaged to an inner wall of the lower piston 120. An outer middle part of the lower piston 120 is protruded with a flange 121. A plurality of slots 122 are formed in the flange 121. A lower side of the lower piston 120 is biforked into an inner ring 123 and an outer ring 124.

An elastic sheet 600 is a round cylinder and is tightly engaged into a recess 402 in an inner wall of the upper piston 400. A lower side of the elastic sheet 600 resists against an upper wall of the flange 121 of the lower position 120. Referring to FIG. 1-1, a lower outer wall of the elastic sheet 600 is extended with an elastic outer annular sheet 601 which shields the plurality of through holes 402 in an annular transversal ring 403 of the upper piston 400 from a lower side of the annular transversal ring 403. A lower inner wall of the elastic sheet 600 is extended with an elastic inner annular sheet 602 which shields the plurality of slots 122 in the flange 121 from the upper side of the flange 121.

A lower post 700 has a cylindrical structure with a hollow center and a sealed lower bottom. A lower side of the lower post 700 is formed with a tapered head 701. A tip of the tapered head 701 faces downwards. An upper side of the lower post 700 is tightly engaged with the inner ring 123 of the lower piston 120.

A lower casing 130 is formed by an inner pipe 131 and an outer pipe 132. The inner pipe 131 and the outer pipe 132 are connected at a lower bottom of the outer pipe 132. The outer pipe 132 has a round cylindrical structure and is opened at an upper side thereof. An upper end of the lower casing 130 expands transversally to be engaged into an annular slot 355 in an inner wall of the upper casing 350 above the thread 9. The inner pipe 131 is a round cylinder and is opened at an upper side thereof. An outer ring 123 of the lower piston 120 is tightly engaged to an inner wall of the inner pipe 132 of the lower casing 130. A reduced pipe 133 is extended from a lower end of the lower pipe 131 and has a diameter smaller than that of the lower pipe 131. An upper side of the reduced pipe 133 is protruded into an inner space of the lower pipe 131 and is extended as a shoulder portion 134 which resists against an upper surface of the tapered head 701 of the lower post 700. As illustrated in FIG. 1, an outer wall of the lowest stage 403 of the upper piston 400 movably resists against an inner wall of the outer pipe 131 of the lower casing 130.

A suction tube 15 has an upper end inserted into an inner space of the reduced pipe 133 to resist against an inner wall of the reduced pipe 133 of the lower casing 130.

A washer 8 encloses an uppermost outer wall of the outer pipe 131 of the lower casing 130 and resists against an inner wall of the lower cylinder 352 of the pump upper casing 350.

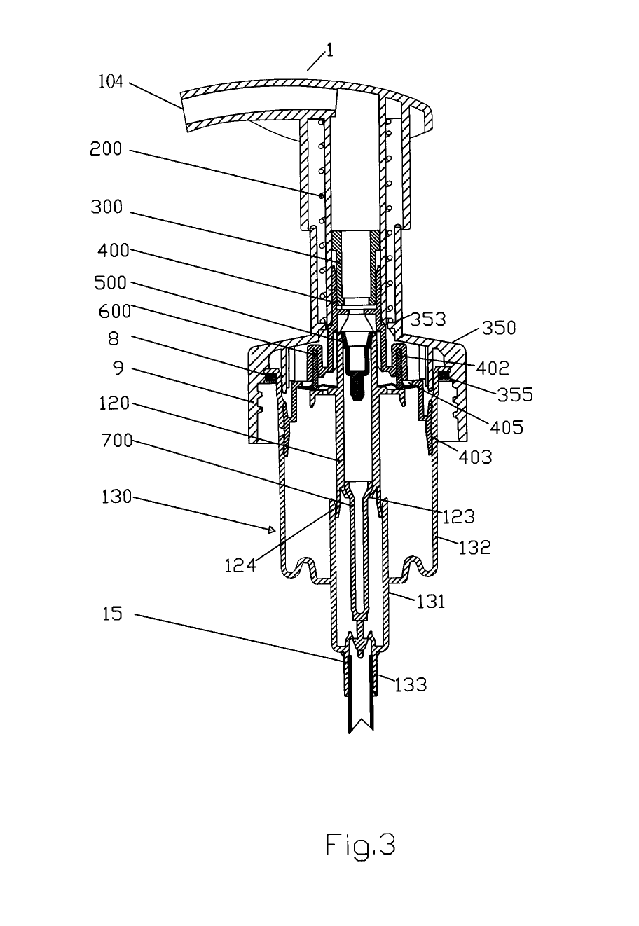

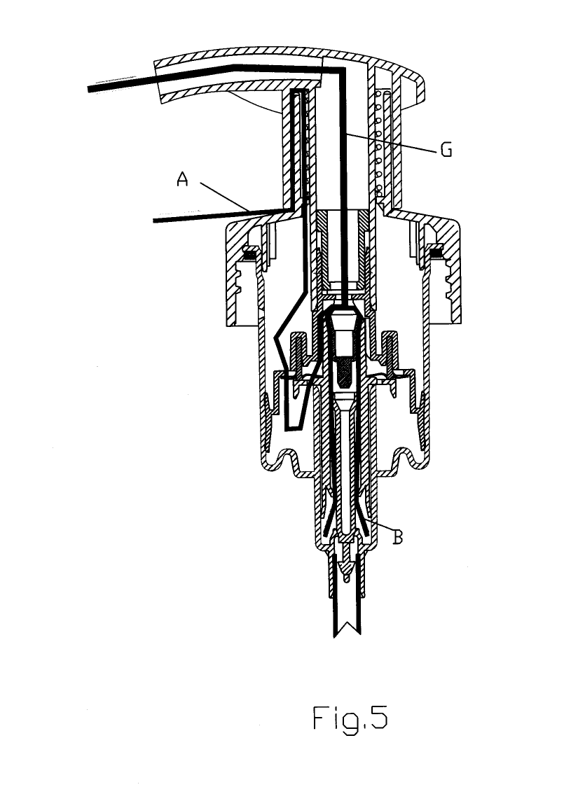

The operation of the present invention will be described herein with reference to FIGS. 3, 4, 5 and 6. In FIG. 5, a path A shows the flow path of the liquid (or emulsion), a path B shows the flow path of the air and a path G shows the flow of the foams which are mixtures of air and liquid (or emulsion).

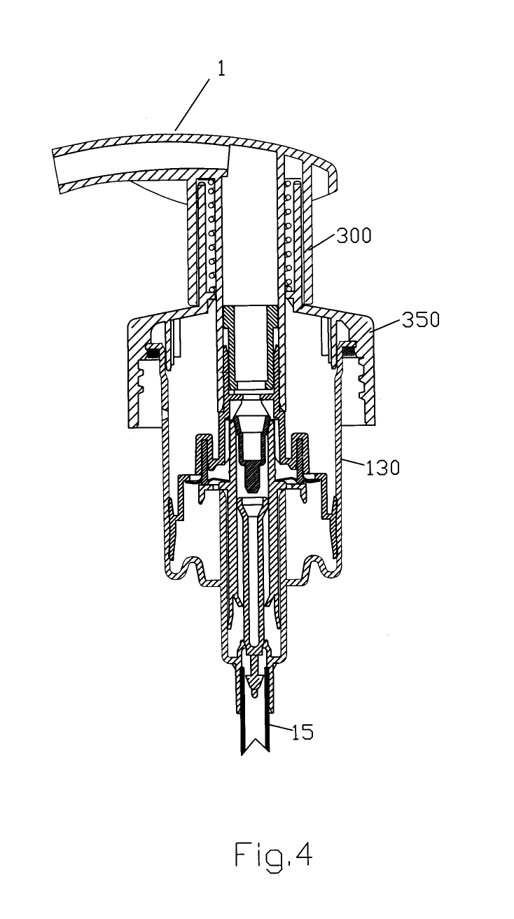

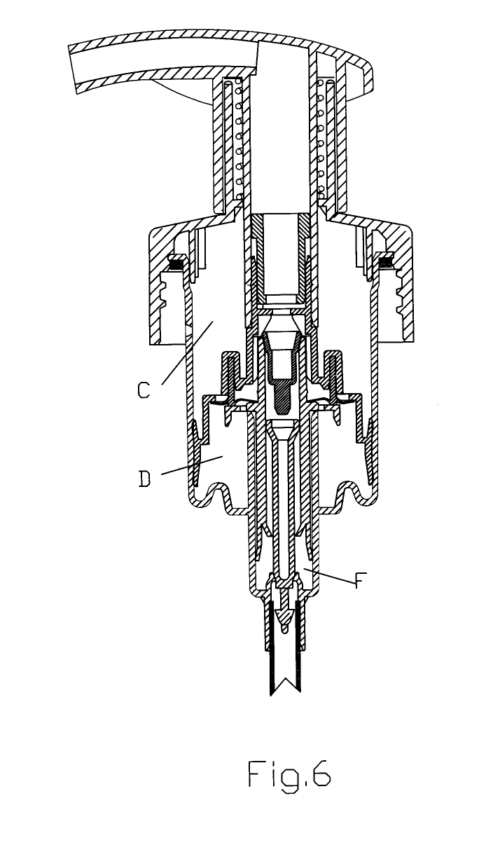

When the pressing head 100 is pressed as illustrated in FIGS. 3 and 4, the spring 200 will be compressed until the flange 121 of the lower post 120 resists against an upper end of the inner pipe 132 of the lower casing 130. The lowest stage 403 of the upper piston 400 will move downwards along the inner wall of the outer pipe 132 of the lower casing. At this moment, air will enter into the space C (see FIG. 6) from the outer side of the foam pump of the present invention and the air originally in the space D (see FIG. 6) will be compressed so as to pass through the slits 122 on the flange 121 of the lower piston 120 and then to eject the inner annular sheet 602 to move upwards and thus the liquid (or emulsion) passes through the slits 122 into the a space between the upper piston 400 and the lower piston 120 and then further enters into the inner space of the net tube 300. The liquid (or the emulsion) in the bottle (not shown) originally filled in the space F (see FIG. 6) will flow through the space between the lower post 700 and the inner ring 124 of the lower piston 120 and then enter into the interior of the net tube 300 along the path B indicated in FIG. 5 as the tapered head 701 of the lower post 700 moves downwards. However the amount of the liquid flows into the space F each time is very little and thus a few times are necessary for pumping liquid into the space F. When the liquid in space F is sufficient, a compressing action of the pressing head 100 cause the liquid in the space F to be compressed to be sucked upwards along the path B shown in FIG. 3. Then the liquid (or emulsion) enters into the inner space of the net tube 300 to be mixed with the air. Since the pressure to mix air and liquid (or emulsion) is very strong and thus the air and liquid (or emulsion) are mixed sufficiently to form as foams which is sucked out from the spraying mouth 104 of the pressing head 100 along the flow line G as illustrated in FIG. 5.

Furthermore, when the pressing head 100 moves upwards, the spring 200 is decompressed until the upper piston 400 resists against an inner wall at the upper inner side of the upper casing 350. The air in the space C will flow through the plurality of through holes 405 in an annular transversal ring 404 of the upper piston 400 and then pull away the elastic outer annular sheet 601 of the elastic sheet 600 to enter into the space D. The shoulder portion 134 tightly resists against the upper surface of the tapered head 701 of the lower post 700 so as to isolate the liquid (or emulsion) flow between the bottle (not shown) and the inner pipe 131 of the flow casing 130.

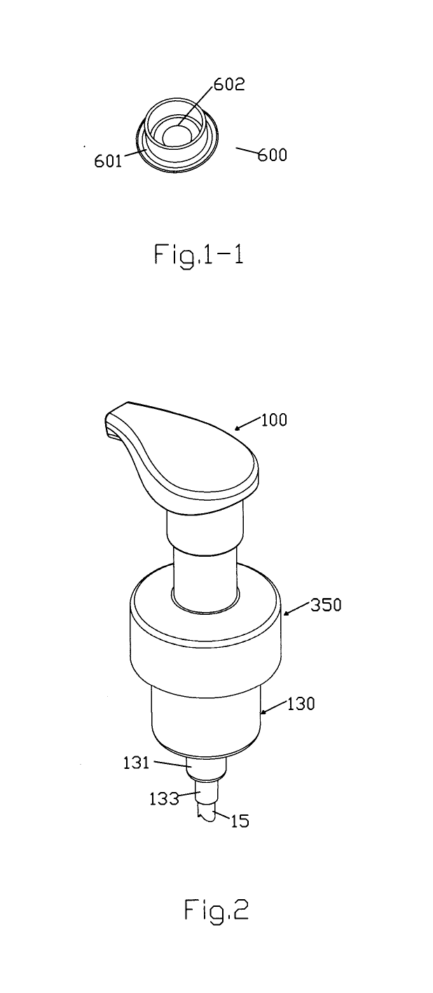

In above mentioned process, the pump output power of the liquid is 0.4 to 2.0 gram (±0.2). The foams from the pump are slender and uniform without any liquid so as to have a preferred effect. In above mentioned process with reference to FIGS. 2 and 3, due to the inner tube and outer tube of the pressing head 100 and the spring 200 installed between the inner tube and the outer tube, in the suction process, the liquid (or emulation) flows through the inner channel of the inner tube and thus it does not contact with the outer tube so that the foams will not be polluted by the spring.

The preferred effects of the present invention is that the spring is isolated with the foaming flow path so that it does not resist the flow of the foams; the liquid (or emulsion) does not contact the foams so that the foams are not polluted and thus the packed objects (liquid or foams) therein is retained purely; the liquid (or emulsion) is not chemically reacted with the material of the spring and thus no harmful object generates; the operation of the present invention is convenient and easy with a steady flow and reliable output.

It should be noted that the foam pumps of the present invention are suitable for the packing bottles of cosmetics, drug sundries, medical things, everyday used articles, etc.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A foam pump with a spring isolated from a flow path, comprising:
a pressing head having a pressing tube at an upper side thereof, an inner tube extending downwards from the pressing tube, and an outer tube enclosing an upper part of the inner tube; a lower part of the inner tube protruding from a lower opening of the outer tube; an inner side of the pressing tube being a hollow channel for outputting foams; the hollow channel of the pressing tube being communicated to the inner tube thereof;
a net tube installed within the inner tube of the pressing head and being communicated to the inner tube of the pressing tube; the net tube having a net-like structure;
a pump upper casing extended from a lower side of the outer tube of the pressing head; an upper side of the pump upper casing being an upper cylinder and a lower part of the pump upper casing being a lower cylinder; a lower inner wall of the lower cylinder of the pump upper casing being formed with threads; a space between the inner tube and outer tube of the pressing head being communicated to an inner space of the pump upper casing at a position above threads; the pump upper casing being slidable along an inner space between the inner tube and outer tube of the pressing head;
a spring winding around the inner tube of the pressing head; a lower end of the spring resisting against an inner flange extending from an inner wall of the pump upper casing;
an upper piston having a multi-stage structure and an upper stage thereof having a smaller diameter than a lower one; the upper piston being opened at an upper side and lower side thereof; the uppermost stage of the upper piston being protruded into a space between the inner tube of the pressing head and the net tube so that the inner space of the upper piston is communicated to the inner channel of the net tube and the inner channel of the inner tube; a plurality of through holes being formed in an annular transversal ring of the upper piston;
an air valve having a reduced size which is reduced from an upper side to a lower side thereof; the air valve having a hollow center which is opened at an upper side thereof; the air valve being communicated to the inner space of the net tube; a lowest part of the air valve having a sealed bottom;
a lower piston having a cylindrical structure with a hollow center; an upper hollow center of the lower piston receiving the air valve so that an upper side of the air valve being tightly engaged to an inner wall of the lower piston; an outer middle part of the lower piston being protruded with a flange; a plurality of slots being formed in the flange; a lower side of the lower piston being biforked into an inner ring and an outer ring;
an elastic sheet being a round cylinder and being tightly engaged into a recess in an inner wall of the upper piston; a lower side of the elastic sheet resisting against an upper wall of the flange of the lower position; a lower outer wall of the elastic sheet being extended with an elastic outer annular sheet which shields the plurality of through holes in an annular transversal ring of the upper piston from a lower side of the annular transversal ring; a lower inner wall of the elastic sheet being extended with an elastic inner annular sheet which shields the plurality of slots in the flange from the upper side of the flange;
a lower post having a cylindrical structure with a hollow center and a sealed lower bottom; a lower side of the lower post being formed with a tapered head; a tip of the tapered head facing downwards; an upper side of the lower post being tightly engaged with the inner ring of the lower piston;
a lower casing formed by an inner pipe and an outer pipe; the inner pipe and the outer pipe being connected at a lower bottom of the outer pipe; the outer pipe having a round cylindrical structure and being opened at an upper side thereof; an upper end of the lower casing expanding transversally to be engaged into an annular slot in an inner wall of the upper casing above the thread; the inner pipe being a round cylinder and being opened at an upper side thereof; an outer ring of the lower piston being tightly engaged to an inner wall of the inner pipe of the lower casing; a reduced pipe being extended from a lower end of the lower pipe and having a diameter smaller than that of the lower pipe; an upper side of the reduced pipe being protruded into an inner space of the lower pipe and being extended as a shoulder portion which resists against an upper surface of the tapered head of the lower post; an outer wall of the lowest stage of the upper piston movably resisting against an inner all of the outer pipe of the lower casing; and
a suction tube having an upper end inserted into an inner space of the reduced pipe to resist against an inner wall of the reduced pipe of the lower casing; and
a washer enclosing an uppermost outer wall of the outer pipe of the lower casing and resisting against an inner wall of the lower cylinder of the pump upper casing.

2. The foam pump with a spring isolated from a flow path as claimed in claim 1, wherein a washer encloses an uppermost outer wall of the outer pipe of the lower casing and resists against an inner wall of the lower cylinder of the pump upper casing.

3. The foam pump with a spring isolated from a flow path as claimed in claim 1, wherein the upper piston is formed as a several stage structures; each stage of the elastic sheet is a round cylinder and is connected to other stage by a transversal sheets; each lower stage of the elastic sheet has a diameter larger than that of the upper stage.

4. The foam pump with a spring isolated from a flow path as claimed in claim 1, wherein the foam pump is suitable for the packing bottles of cosmetics, drug sundries, medical things, and everyday used articles.

5. The foam pump with a spring isolated from a flow path as claimed in claim 1, wherein the pressing head has an elliptical pressing tube.
